(19) United States
(12) Patent Application Publication
(10) Pub. No.: US 2014/0362286 A1
(43) Pub. Date: Dec. 11, 2014

(54) MINIATURE IMAGING AND DECODING MODULE

(71) Applicants: Satoshi Komi, Warabi (JP); Nobuhiro Eebara, Warabi (JP); Yasutake Kawashima, Warabi (JP); Ken Fukuba, Warabi (JP)

(72) Inventors: Satoshi Komi, Warabi (JP); Nobuhiro Eebara, Warabi (JP); Yasutake Kawashima, Warabi (JP); Ken Fukuba, Warabi (JP)

(73) Assignees: OPTICON, INC., Renton, WA (US); OPTOELECTRONICS CO., LTD., Saitama (JP)

(21) Appl. No.: 14/353,614

(22) PCT Filed: Dec. 12, 2011
(86) PCT No.: PCT/US2011/064327

§ 371 Date: Jul. 17, 2014

(51) Int. Cl. H04N 5/225

(52) U.S. Cl. CPC H04N 5/2253; H04N 5/2254
USPC 348/374

(57) ABSTRACT

An imaging module for an image scanning and/or reading device, contains a camera module, a decoder module, and a chassis module for mounting the camera and decoder modules. The camera module includes a module body having a surface for receiving a circuit board, the surface including one or more recessed portions for preventing damage to the body when the one or more contacts of the circuit board are soldered. The decoder module includes a folded circuit board arrangement including parallel first and second circuit boards. The chassis module includes a main chassis having a portion that engages a processor of the decoder module to transfer heat from the processor into the main chassis.

### FIELD

The present disclosure relates to devices for imaging. More particularly, the present disclosure relates to a miniature imaging and decoding module for an image scanning and reading device such as a barcode reading device or an optical character recognition reader.

### BACKGROUND

Optical image scanning and reading devices read symbols such as barcodes that represent data about a product or service. A barcode is an optical machine-readable label attached to an object, which directly or indirectly represents information about the object or a service associated with the object. Such information can include, without limitation, vendor identification, product name, price, patient name and other descriptive information about the object. Barcode reading devices are widely used in distribution, retail and many other industries for reading barcodes.

Often, such devices are based upon charge coupled device (CCD) or CMOS technology, wherein a linear array CCD or CMOS device is used to recover light reflected from the barcode. In such systems, plural LEDs are used as a light source to illuminate an object such as a barcode. The reflected light is received by the CCD or CMOS linear array, which converts the light energy into electrical energy. The varying electrical signal can then be processed to recover the barcode symbol, which represents the information of interest.

The current trend is to reduce the size and weight of the image scanning and reading device to make it easier to use and less expensive to manufacture. This, in turn, requires the use of a dimensionally more compact imaging module.

Accordingly, a miniature imaging and decoding module is needed.

### SUMMARY

Disclosed herein is an imaging module for an image scanning and/or reading device. The imaging module in one exemplary embodiment comprises a camera module comprising a module body having a surface for receiving a circuit board, the surface including one or more recessed portions for preventing damage to the body when the one or more contacts of the circuit board are soldered.

The imaging module in another exemplary embodiment further comprises a decoder module and a chassis module for mounting the camera and decoder modules.

The decoder module in some embodiments comprises a folded circuit board arrangement including parallel first and second circuit boards.

The chassis module in some embodiments comprises a main chassis having a portion that engages a processor of the decoder module to transfer heat from the processor into the main chassis.

Further disclosed herein is a method for automatically determining optimal object illumination in an imaging module. In one exemplary embodiment, the method comprises determining whether an image of an object captured by the module can be decoded and adjusting the exposure using exposure control and illumination intensity parameters stored in a memory of the module if the image is determined to not be decodable.

Also disclosed herein is a method for automatically generating correct image exposure in an imaging module. In one exemplary embodiment, the method comprises capturing a first image of an object, dividing an imaging area into multiple blocks with each of the blocks having a different target brightness gain value, and attempting to decode the image using the gain value of the selected blocks, until a target brightness gain value is selected that allows the image to decode successfully.

### BRIEF DESCRIPTION OF THE DRAWINGS

FIG. 1 is an exploded perspective view of a miniature imaging and decoding module, according an exemplary embodiment of the present disclosure.

FIG. 2A is an exploded perspective view of a chassis module of the imaging and decoding module according an exemplary embodiment of the present disclosure.

FIG. 2B is a rear perspective view of an exemplary embodiment of a main chassis of the chassis module.

FIG. 2C is a top perspective view of the imaging and decoding module showing a camera module and a decoder module mounted in the main chassis of the chassis module.

FIG. 2D is a side sectional view of the of the imaging and decoding module showing the camera module and the decoder module mounted in the main chassis of the chassis module.

FIG. 3A is an exploded perspective view of the camera module of the imaging and decoding module, according an exemplary embodiment of the present disclosure.

FIG. 3B is a front perspective view of the camera module.

FIG. 3C is a rear perspective view of the camera module.

FIG. 3D is a front perspective view of the camera module without an interconnect printed circuit board.

FIG. 3E is a block diagram depicting the operation of the illumination and aiming systems of the imaging and decoding module.

FIG. 4A is an exploded perspective view of the decoder module according an exemplary embodiment of the present disclosure.

FIG. 4B is an exploded side view of the decoder module.

FIG. 4C is an assembled side view of the decoder module.

FIG. 5 is an exploded side view of the camera and decoder modules.

FIG. 6 is a block diagram of an exemplary embodiment of the camera and decoder modules.

FIGS. 7A-7C are bottom, side and top views, respectively of the decoder module depicted in FIG. 6 in an unfolded state.

FIG. 8A is a graph showing the relative luminous intensity of a yellow LED, an amber LED, and a red LED, versus temperature.

FIG. 8B is a graph showing illumination LED pulse width versus temperature.

FIG. 8C is a graph showing CPU clock frequency versus temperature.

FIG. 9 is a flow chart of a method performed by the CPU of the decoder module for automatically calculating the optimal exposure values using factory settings stored in a memory of an image sensor PCB of the camera module. according to an exemplary embodiment of the present disclosure.

FIG. 10A is a flow chart of a method performed by the CPU of the decoder module for generating the proper image exposure in a first captured image of an object according to an exemplary embodiment of the present disclosure.

FIG. 10B is an image of the object captured by the imaging and decoding module showing the imaging area of the module divided into multiple blocks of different target brightness gain values, according to the method of FIG. 10A.

FIG. 10C is a schematic diagram showing the selection of the block with the proper image exposure or brightness gain value and the subsequent output of the image at the brightness gain value of the selected block, according to the method of FIG. 10A.

FIG. 10D is shows the outputted image at the brightness gain value of the selected block.

### DETAILED DESCRIPTION

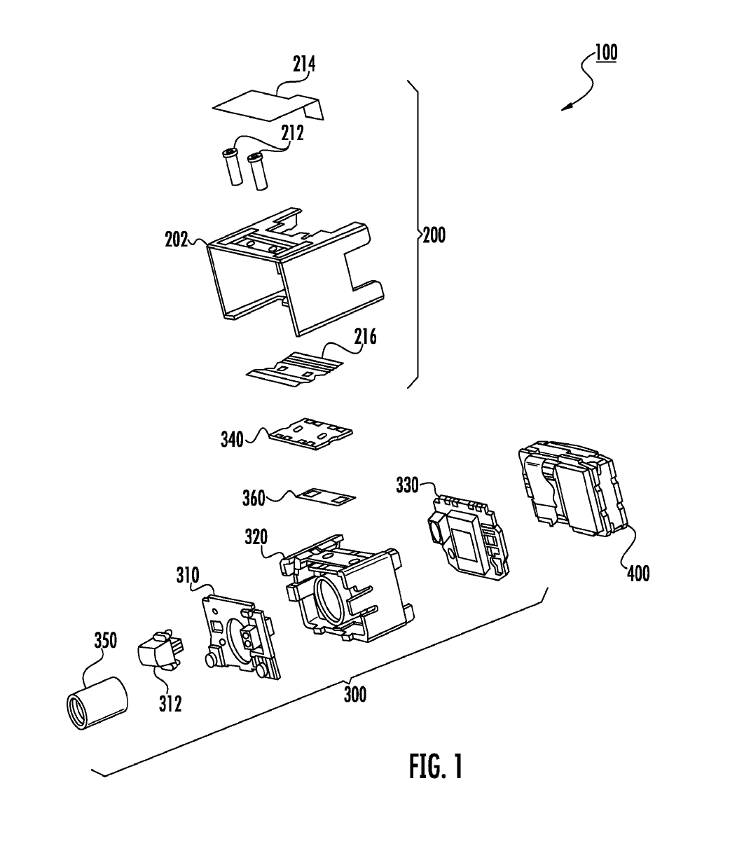

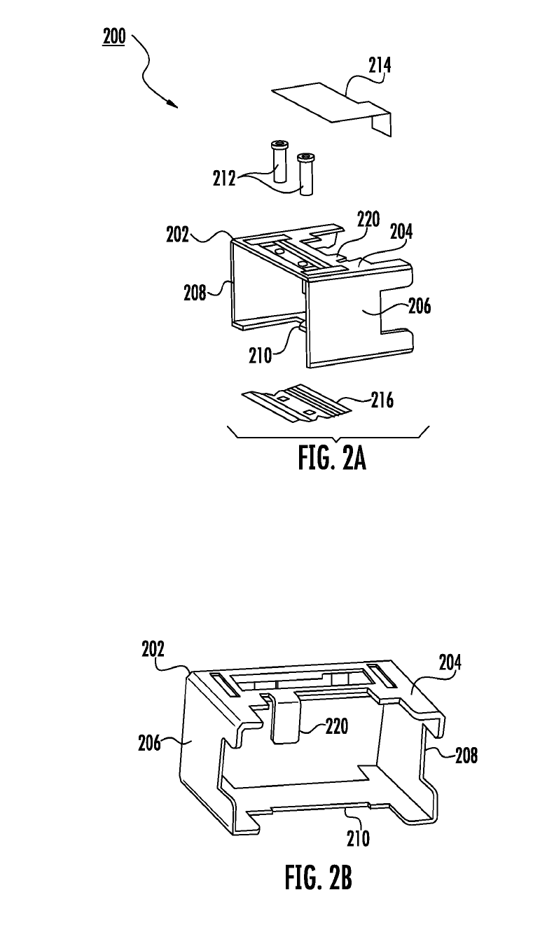

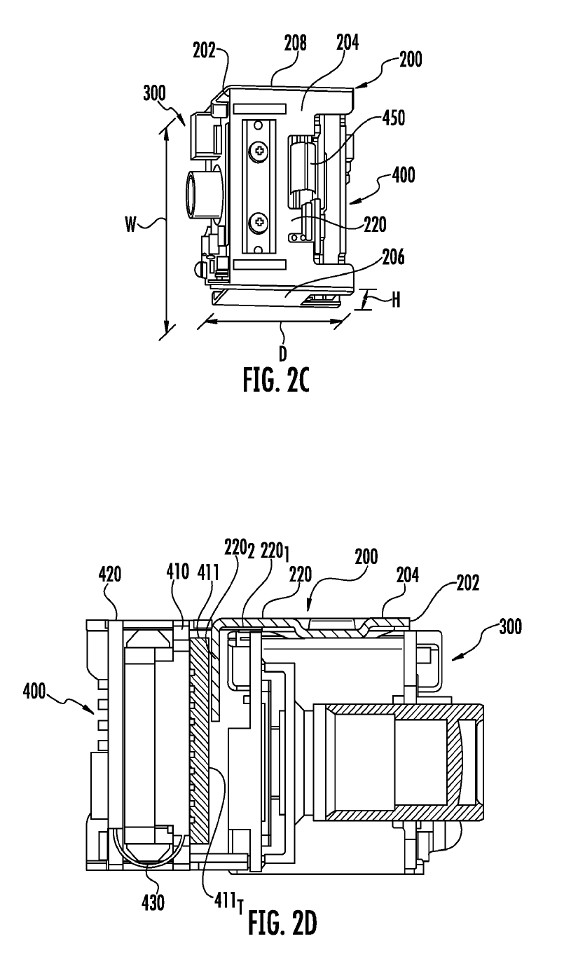

FIG. 1 is an exploded view of a miniature imaging and decoding (I/D) module 100, according an exemplary embodiment of the present disclosure. The I/D module 100 can be used in an image scanning and reading device including, without limitation, a barcode reading device and an optical character recognition reader. The I/D module comprises a chassis module 200, a camera module 300 and a decoder module 400. The I/D module 100 may have a cubic structure as shown in the top perspective view of FIG. 2C with a length or depth D of 21.0 mm, a width W of 25.3 mm, and a height H of 12.4 mm. In other embodiments, the I/D module 100 may have other dimensions.

Referring to FIGS. 2A-2D, the chassis module 200 comprises a main chassis 202 having a top wall 204, a pair of opposing side walls 206, 208 and a bottom wall 210. The camera and decoder modules 300, 400 are disposed within the main chassis 202. Screw fasteners 212 or any other suitable fastening system can be used for retaining the camera module 300 inside the main chassis 202. A flexible printed circuit (FPC) electrically and mechanically connects the camera and decoder modules 300, 400. A shield sheet 214 electrically connects the main chassis 202 and a ground on a second main printed circuit board 420 of the decoder module 400 to prevent electrostatic discharge (ESD) damage. An insulation sheet 216 is disposed between the top wall 204 of the main chassis 202 and a body 320 of the camera module 300 to prevent electrical short circuits.

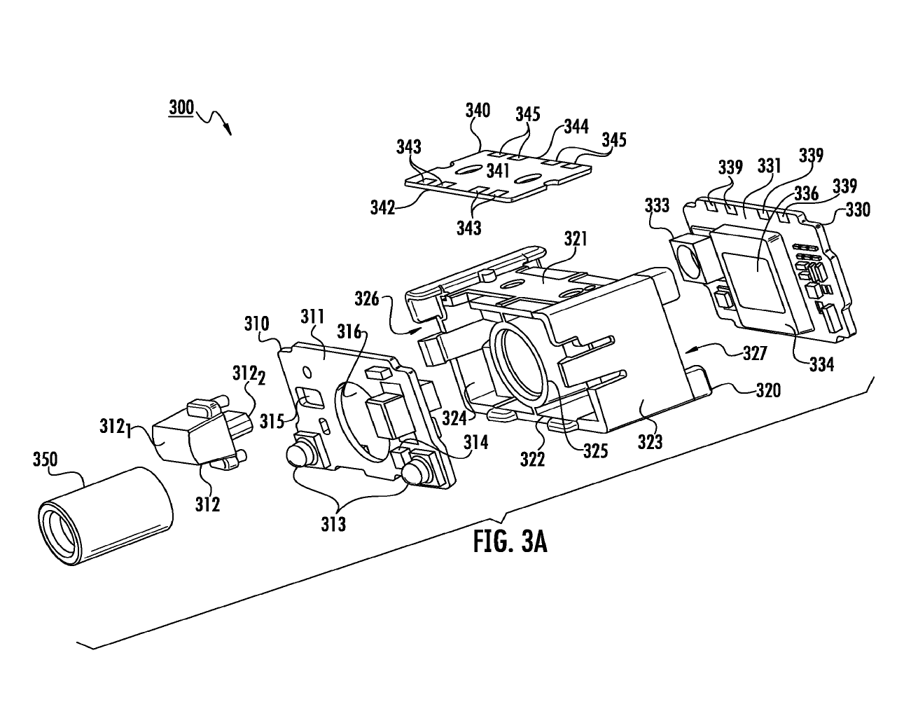

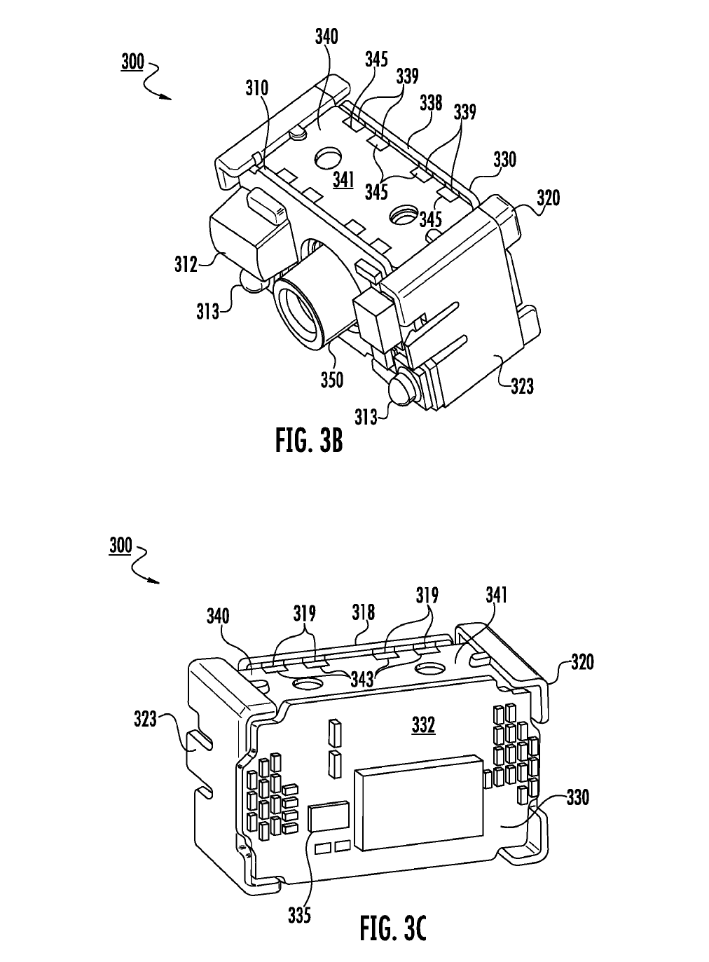

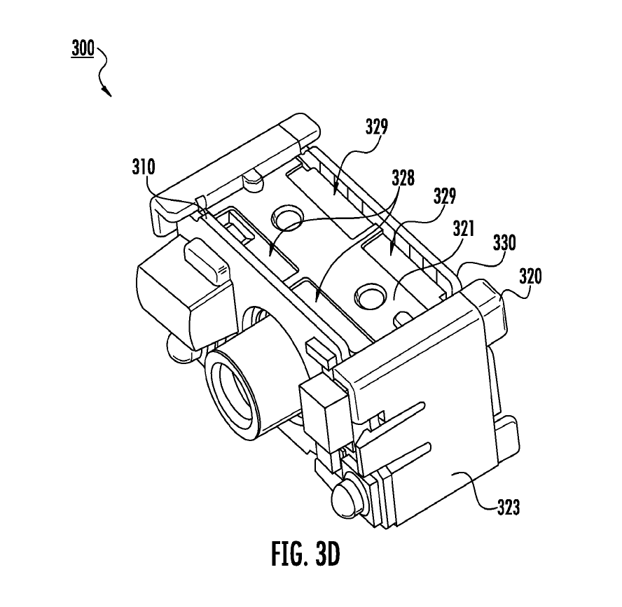

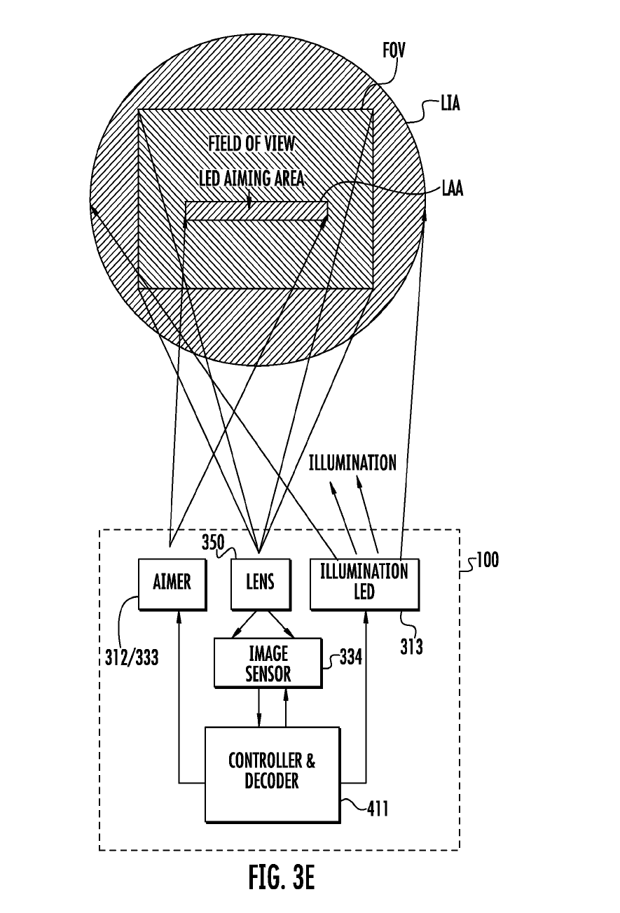

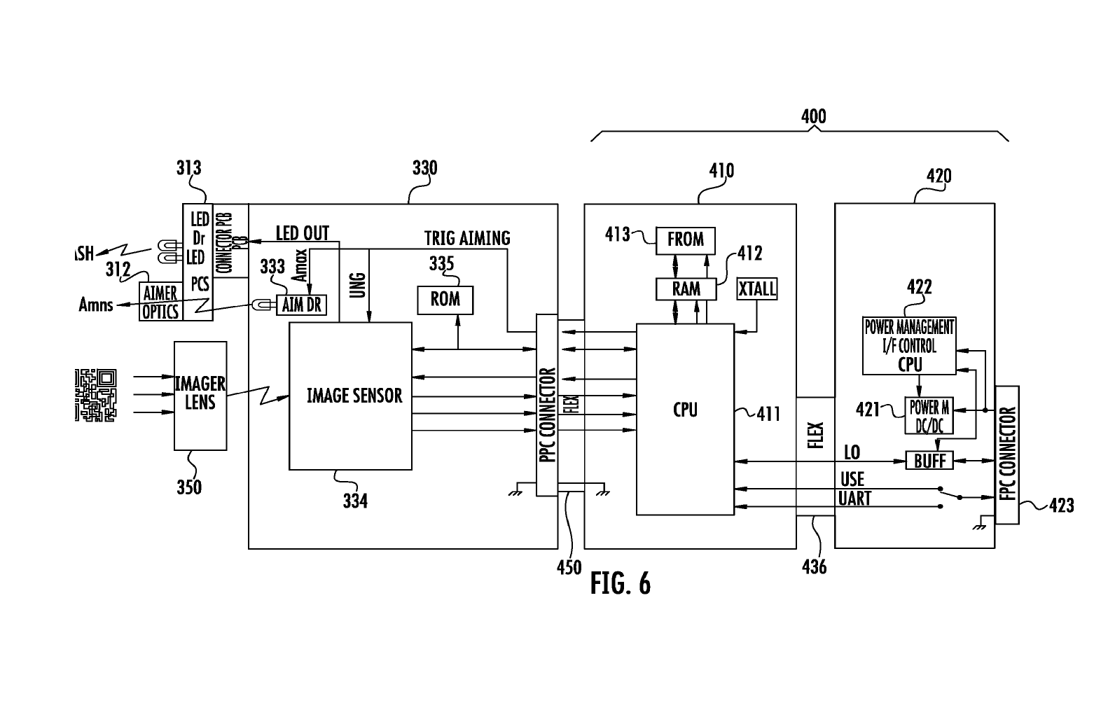

Referring to FIGS. 3A-3D and FIG. 6, the camera module 300 comprises an illumination system printed circuit board (PCB) 310, a camera body 320, an image sensor PCB 330, and an interconnect PCB 340. The illumination system PCB 310 is mounted on a front side 326 of the camera body 320, the interconnect PCB 340 is mounted on a top wall 321 of the camera body 320, and the image sensor PCB 330 is mounted on a rear side 327 of the camera body 320.

The illumination system PCB 310 includes an aiming lens 312, two illumination LEDs 313, and a temperature sensor 314 mounted on a forward facing surface 311 of the illumination system PCB 310. The aiming lens 312 can include a cylindrical front surface 312₁ and a cylindrical rear surface 312₂ which is perpendicular to the front surface 312₁ and which extends to the image sensor PCB 330 through a first aperture 315 in the illumination system PCB 310 and through an open portion of the camera body 320. The aiming lens 312 can be a plastic lens made for example, of a polycarbonate engineering plastic. As shown in FIG. 3E, the illumination LEDs 313 generate an LED illumination area LIA.

Referring again to FIGS. 3A-3D and FIG. 6, the camera body 320 includes the earlier mentioned top wall 321, a bottom wall 322, side walls 323 and 324, a cylindrical section 325 extending between the top and bottom walls 321, 322. The camera body 320 can be made from any suitable material, such as, but not limited to, plastic resin. An image focusing lens 350 is mounted in the cylindrical section 325 of the camera body 320 and extends through a second aperture 316 in the illumination PCB 310. The image focusing lens 350 can be a variable focus or fixed focus lens set.

The image sensor PCB 330 includes an aiming LED chip 333 and the image sensor 334 mounted on a forward facing surface 331 thereof, and a memory 335 mounted on a rearward facing surface 332 thereof (FIG. 3C). The field of view (FOV) of the image sensor 334 (FIG. 3E) is disposed within the LED illumination area LIA generated by the illumination LEDs 313. The light produced by the aiming LED chip 333 impinges on the front and rear surfaces 312₁, 312₂ of the aiming lens 312. The surfaces 312₁ and 312₂ of the aiming lens 312 control the emission angle of the impinging light wherein surface 312₁ focuses the light in a vertical direction and surface 312₂ focuses the light in the horizontal direction. Accordingly, the aiming LED chip 333 produces a horizontally elongated LED aiming area LAA within the field of view FOV of the image sensor 334.

The image sensor 334 is aligned with the focusing lens 350, so that the lens 350 can focus light reflected back from the object onto the image sensor 334 which converts this light into a digital signal that contains data representing the image of the object. The image sensor 334 can comprise a CMOS image sensor, a CCD image sensor, or any other suitable image sensing device that is capable of converting the light reflected from the object into a digital signal that contains data that represents the image of the object. The structure and operation of such image sensors are well known in the art. An IR cutoff filter 336 can be disposed between the image sensor 334 and the image focusing lens 350, for removing infrared rays to improve visual quality. In one exemplary embodiment, the IR filter 336 is provided as a coating on a cover glass of the image sensor 334 to reduce the manufacturing cost of the I/D module 100.

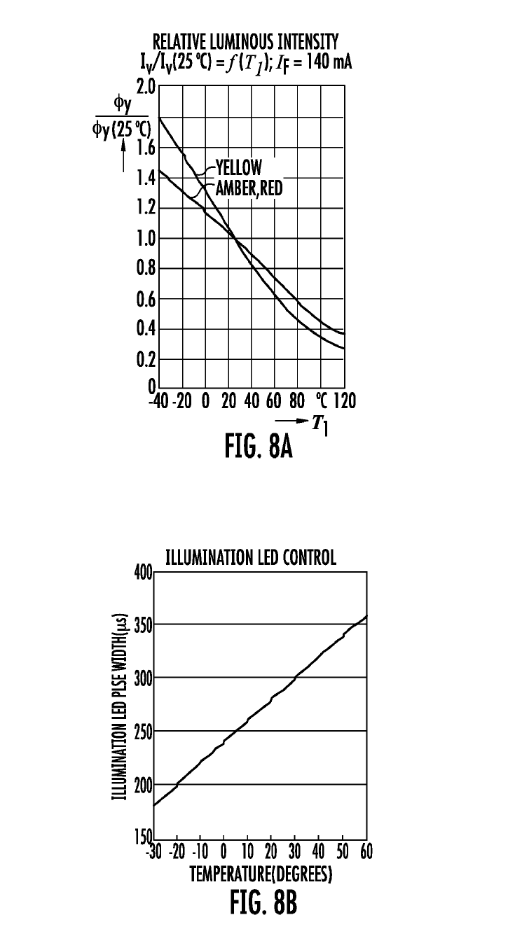

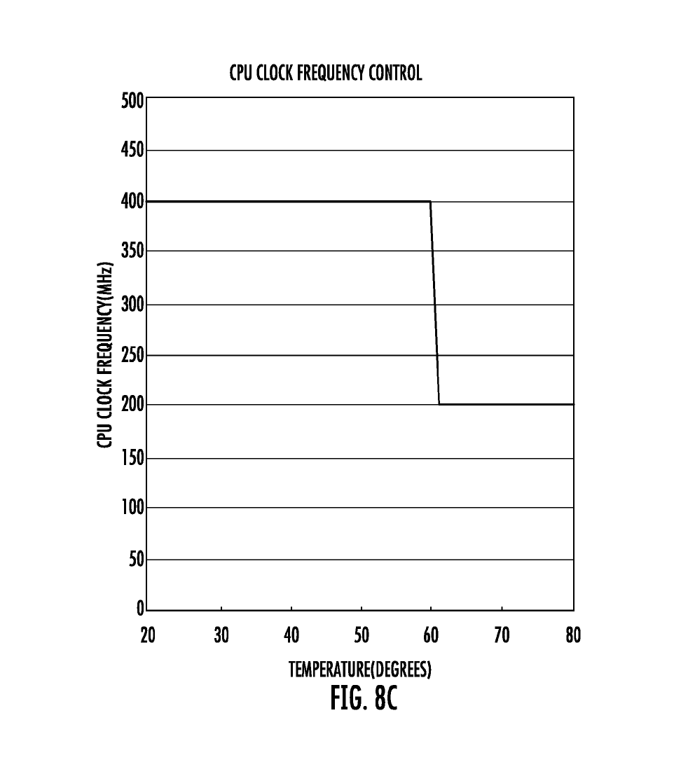

The memory 335, which may comprise a read-only-memory (ROM), is a component of the camera module 300 instead of a component of the decoder module, as in prior art imaging modules. In addition, the memory 335 is programmed with specific module parameters (factory settings) including without limitation LED illumination intensity, image sensor noise, an automatic exposure control function, a focusing function, aiming shape, the I/D module ID, and the I/D module manufacturing date. Providing the memory 335 (with the stored module parameters) in the camera module 300 eliminates the need to manage the camera and decoder modules 300, 400 in pairs, as is required in prior art imaging modules, and increases production and distribution efficiencies. Further, because of variations in LED brightness, as shown in the graph of FIG. 8A, the LED illumination intensity and the automatic exposure control function parameters stored in the memory 335 of the camera module 300 allow an optimal exposure value to be calculated quickly and easily by a central processing unit 411 (CPU) of the decoder module 400.

Referring again to FIGS. 3A-3C, the interconnect PCB 340 is disposed on the top wall 321 of the camera body 320 and electrically connects the illumination system PCB 310 with the image sensor PCB 330. The top surface 341 of the connect PCB 340 includes one or more metallic electrical contact pads 343 adjacent a front edge 342 thereof and one or more metallic contact pads 345 adjacent a rear edge 344 thereof. The one or more contact pads 343 are electrically connected by electrically conductive pathways or tracks (not shown) to the one or more contact pads 345. As shown in FIG. 3C, the one or more contact pads 343 of the interconnect PCB 340 are soldered to one or more corresponding contact pads 319 disposed on a rearward facing surface 317 of the illumination system PCB 310, adjacent to a top edge 318 thereof. The contact pads 319 electrically communicate with the hardware and circuitry of the illumination PCB 310. As shown in FIG. 3B, the one or more contact pads 345 of the interconnect PCB 340 are soldered to one or more corresponding contact pads 339 disposed on the forwardly facing surface 331 of the image sensor PCB 330, adjacent to a top edge 338 thereof. The contact pads 339 electrically communicate with the hardware and circuitry of the image sensor PCB 330. A layer of adhesive 360 (e.g., double-sided tape) can be provided between the top wall 321 of the camera body 320 and the connect PCB 340 (FIG. 1) to prevent the connect PCB 340 from moving and tilting during the soldering of the contact pads.

Referring to FIG. 3C, the top wall 321 of the camera body 320 can include one or more recessed surface portions 328, 329 at the front and rear margins of the top wall 321. The front and rear recesses or wells 328, 329 are disposed underneath the one or more contact pads 343, 345 of the interconnect PCB 340 to prevent direct heat transfer and thus, damage to the top wall 321 of the camera body 310 when the contact pads 343, 345 of the connect PCB 340 are soldered to the contact pads 319 and 339 of the illumination system and image sensor PCBs 310 and 330, respectively.

It is important to quickly optimize the image exposure of the I/D module 100 to realize fast scanning speeds. However, because the relative luminous intensity of the illumination LEDs 313 varies with ambient temperature, as shown in FIG. 8A, the image exposure will vary also. Consequently, it takes time to optimize image exposure, which in turn slows the scanning speed of the I/D module 100. Accordingly, the I/D module 100 of the present disclosure includes the earlier described temperature sensor 314, which monitors the temperature of the module's environment. The temperature sensor 314 can comprise a thermistor or any other suitable temperature sensor. The CPU 411 of the decoder module 400 monitors the temperature sensor 334 and adjusts the pulse width of the illumination LEDs 313 to compensate the change in luminous intensity with temperature, as shown in FIG. 8B. When the I/D module 100 is used outside of the specified temperature range of the module, the temperature sensor 314 can be used to reduce the clock frequency the CPU 411 as shown in FIG. 8C to restrain heat generation and prevent malfunction of the CPU 411.

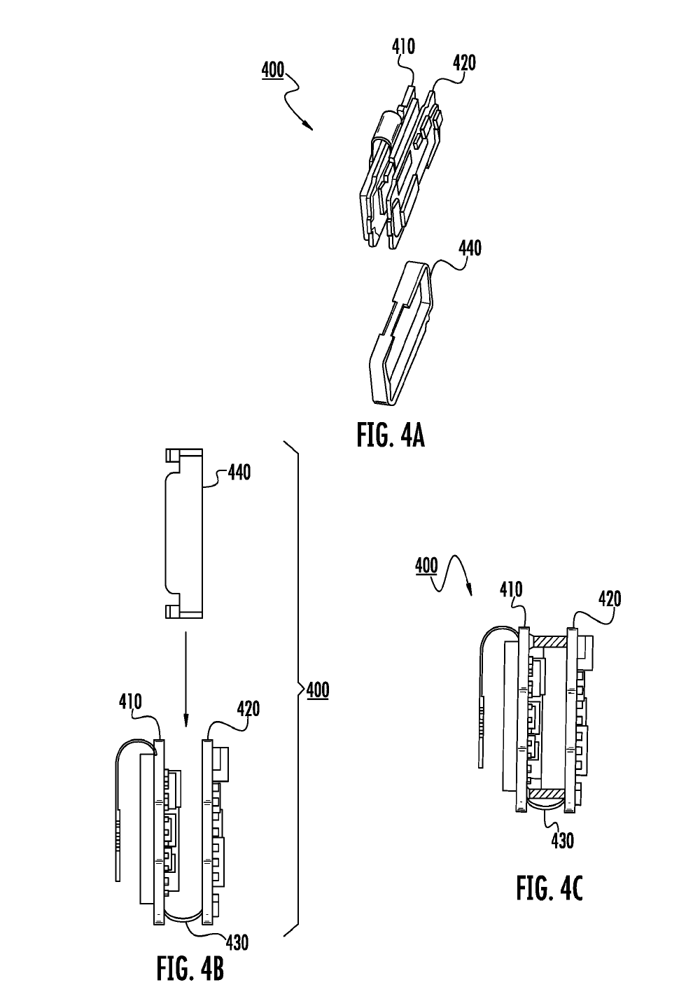

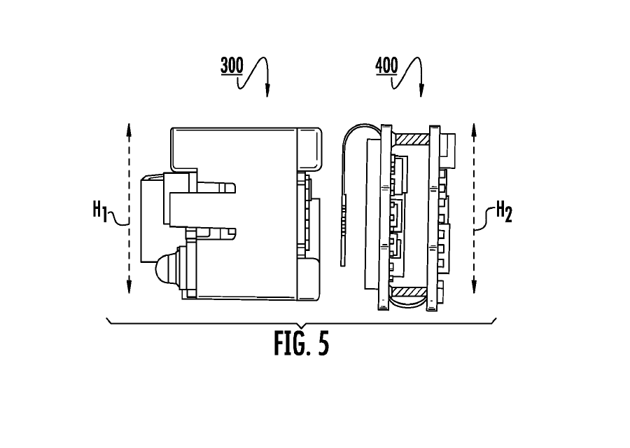

Referring now to FIGS. 4A-4C, the decoder module 400 is a folded PCB structure comprising a first main PCB 410 and a second main PCB 420 electrically and mechanically connected to the first main PCB 410 by a first flexible printed circuit (FPC) 430. The first FPC 430 allows the decoder PCB 410 and interface PCB 420 to be folded together so that they are parallel with one another. To prevent electrical shorting due to board to board contact, a ring-shaped spacer 440, made for example, of a resin material, can be disposed between the first and second main PCBs 410, 420 to ensure that the components mounted thereon do not interfere with one another. The folded decoder module 400 provides a compact structure that allows the dimensions of the I/D module 100 of the present disclosure to be reduced. For example, in the exemplary embodiment shown in FIG. 5, the height H2 of folded decoder module 400 is approximately the same as the height H1 of the camera module 300, thereby, allow the overall height of the I/D module 100 to be substantially reduced.

The decoder module 400, in some embodiments, can be oriented in the chassis module 200 so that the first main PCB 410 is disposed adjacent to the image sensor PCB 330 (camera side) of the camera module 300 and the second main PCB 420 is accessible for interfacing with a host device, such as a barcode reading or optical character recognition device (host side). A second FPC 450 (shown in FIG. 2C and FIG. 6) connects the first main PCB 410 to the image sensor PCB 330 of the camera module 330. The first and second FPCs 430, 450 allow the hardware and circuitry of the camera and decoder modules 300, 400 electrically communicate with one another.

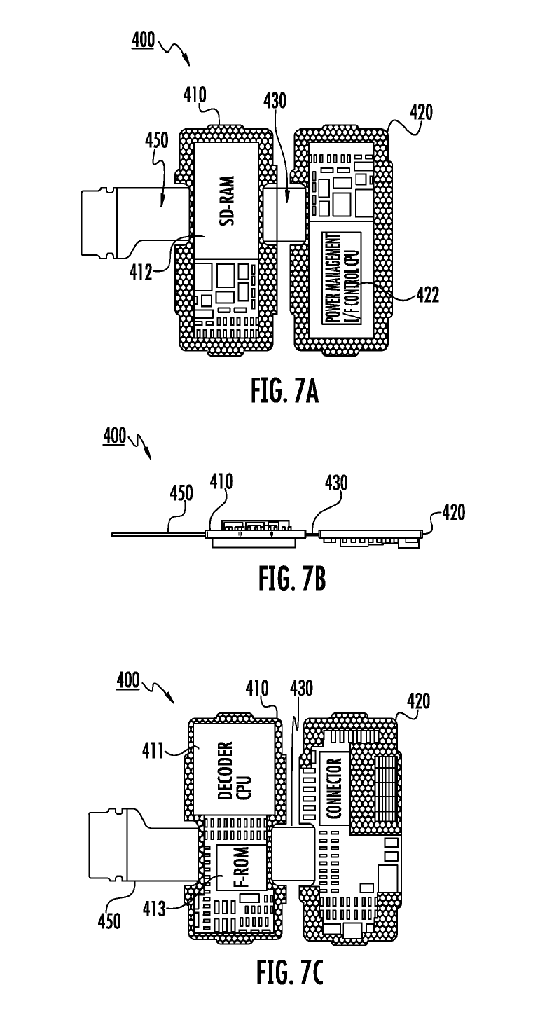

FIG. 6 is a block diagram of the image sensor PCB 330 described earlier and a preferred exemplary embodiment of the decoder module 400. FIGS. 7A-7C are bottom, side and top views, respectively of the decoder module 400 depicted in FIG. 6 in an unfolded state. As shown therein, the first main PCB 410 includes the CPU 411 mentioned earlier and first and second memories 412 and 413 (e.g., a random-access-memory (RAM) and a read-only-memory (ROM)), that operate together to control the image sensor 334, and the second main PCB 420 includes a module power supply 421, and a power management and interface control CPU 422. Locating the CPU 411 and the memories 412, 413 together on the first main PCB 410 (camera side of the decoder module 400) minimizes signal line length and the number of rigid flex wires in the FPC 430, and therefore minimizes electrical noise. Similarly, locating the interface control CPU 422 on the second main PCB 420 (host side of the decoder module 400) minimizes the electrical connection of the interface control CPU 422 to interface connector 423 on the second main PCB 420, which in turn, minimizes the effect of noise caused by interface signals.

In another exemplary embodiment (not shown), the first main PCB 410 can include the CPU 411 and the RAM 412, and the second main PCB 420 can include the ROM 413, the module power supply 421, and the power management and interface control CPU 422. In still another exemplary embodiment, the first main PCB 410 can include the CPU 411 and the RAM 412, the ROM 413, and the module power supply 421, and the second main PCB 420 can include the power management and interface control CPU 422. In still a further embodiment, the first main PCB 410 can include the CPU 411 and the RAM 412, and the module power supply 421, and the second main PCB 420 can include the ROM 413 and the power management and interface control CPU 422.

Heat can build up in the I/D module 100 because its structure confines heat generating components, such as the CPU and the ROM, into a small space. Therefore, as shown in FIG. 2D, the top wall 204 of the main chassis 202 of the chassis module 200 may include a heat transfer flange 220 that operates to transfer heat into the main chassis 202, which in turn transfers the heat into the surrounding air. The flange 220 can have an L-shape profile formed by a first member 220₁ that extends from a top wall 204 thereof, and a second member 220₂ that extends down from the first member 220₁ between the image sensor PCB 330 of the camera module 300 and the first main PCB 410 of the decoder module 400. The second member 220₂ of the flange 220 engages a top surface 411_{T} of the CPU 411 mounted on the first main PCB 410 of the decoder module 400. The flame 220 transfers heat generated by the CPU 411 into the main chassis 202. The relatively large surface area of the main chassis 202 transfers the heat into the surrounding air. Accordingly, the flange 220 allows the main chassis 220 to operate as a heat sink to cool the CPU 411 and reduce the heat build up in the I/D module 100. The main chassis 202 can be made of an aluminum or zinc alloy, or any other suitable metal alloy or metal that can be formed with sufficient accuracy and strength.

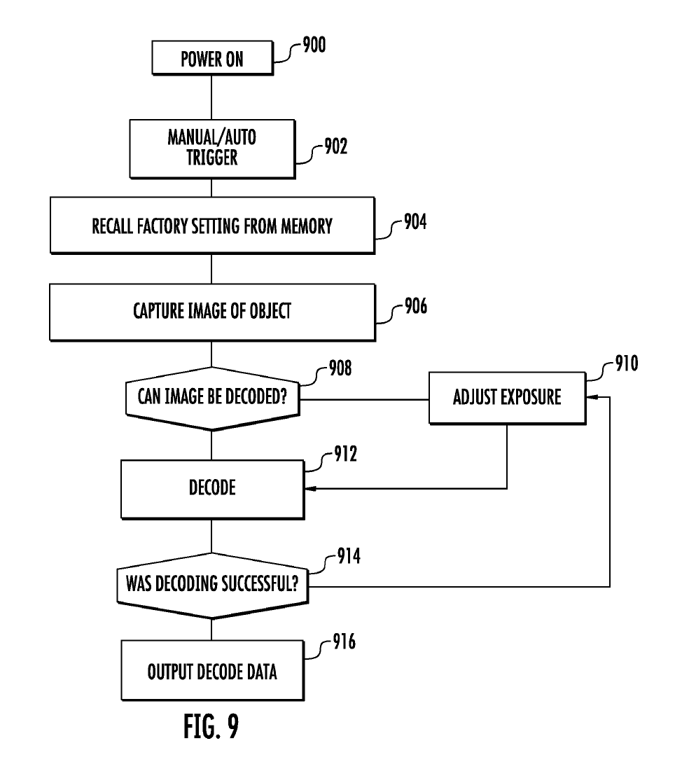

Some exemplary embodiments of the VD module 100 are capable of automatically calculating sensor gain and exposure period settings (which correct for LED variation) to obtain optimal exposure values using the earlier described factory settings stored in the memory 335 of the image sensor PCB 330 using the method depicted in the flow chart of FIG. 9 which method is performed by the CPU 411 of the decoder module 400. In step 900, the I/D module 100 is powered on, and in step 902 the automatic exposure control function of the I/D module 100 is manually triggered by the user or automatically triggered by the CPU 411 after an object is detected. In step 904, the CPU 411 calls up the auto exposure control function (which selects table settings for exposure period (shutter period) and image sensor gain depending upon the LED brightness) and LED illumination intensity parameters from the memory 335 of the image sensor PCB 330. In step 906, an image of the object is captured by the image sensor 334 of the I/D module 100. In step 908, the CPU 411 determines whether the image can be decoded and if so, attempts to decode the image in step 912. In step 914, the CPU 411 determines whether the image was successfully decoded in step 912 and if so, outputs the decoded image in step 916. If the CPU 411 determines that the image can not be decoded in step 908, the CPU 411 adjusts the exposure period and image sensor gain of the I/D module 100 in step 910 according to the automatic exposure control function and LED illumination intensity parameters uploaded from the memory 335 and attempts to decode the image in step 912. In step 914, the CPU 411 determines whether the image was successfully decoded in step 912 and if so, outputs the decoded image in step 916. If CPU 411 determines that the image has not been successfully decoded, the CPU 411 repeats steps 910, 912, and 914 until the image has been successfully decoded and then outputs the decoded image in step 916.

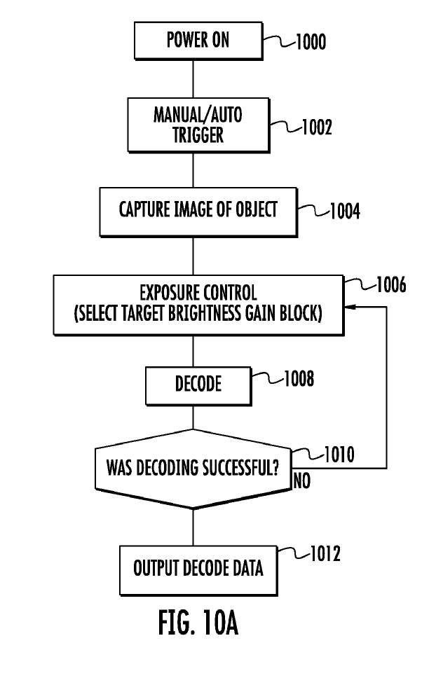

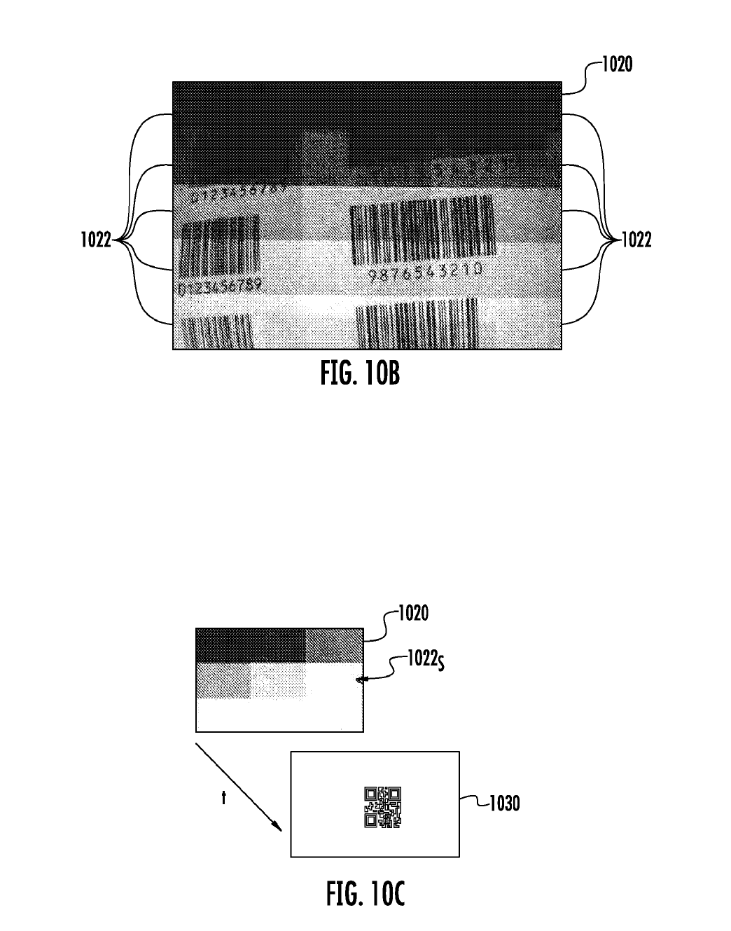

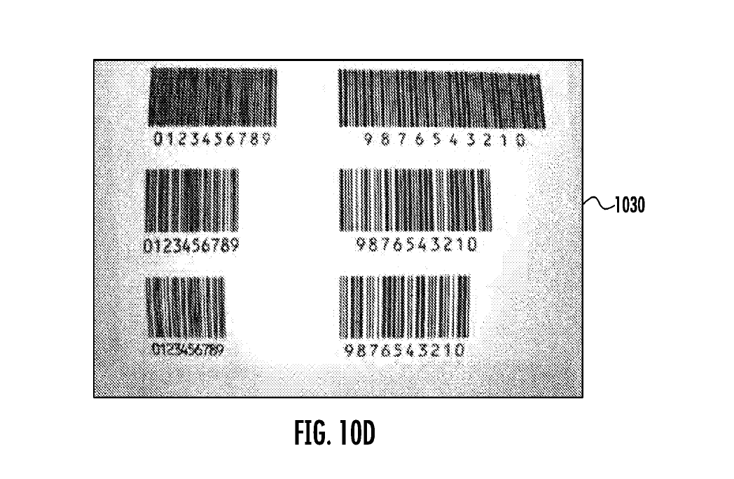

Some exemplary embodiments of the I/D module 100 are capable of automatically generating the proper image exposure in a first captured image of an object. FIG. 10A is a flow chart of a method performed by the CPU 411 of the decoder module 400 for generating the proper image exposure in the first captured image of the object according to an exemplary embodiment of the present disclosure. The I/D module 100 is powered on in step 1000, and the automatic exposure control function is manually triggered by the user or automatically triggered by the CPU 411 after the object is detected in step 1002. In step 1004, an image of the object (e.g., plural barcodes) is captured by the image sensor 334 of the I/D module 100 for exposure adjustment. In step 1006, the CPU 411 divides the imaging area 1020 of the image sensor 334 into multiple blocks 1022, as shown in FIG. 10B, and sets each of the blocks 1022 to a different target brightness gain value, and selects a first one of the blocks to decode. In step 1008, the CPU 411 attempts to decode the image at the gain value of the selected block 1022_{S} and determines in step 1010 whether the image was successfully decoded. If the image decoded successfully, the CPU 411, outputs the decoded image 1030 in step 1012 as shown in FIGS. 10C and 10D. If CPU 411 determines that the image did not decode successfully, the CPU 411 returns to step 1006 where it selects the gain value of another one of the blocks 1022 and then repeats steps 1008 and 1010 until it finds a target brightness gain value that meets the decoding conditions and then outputs the decoded image 1030 in step 1012 as shown in FIGS. 10C and 10D.

While exemplary drawings and specific embodiments of the present disclosure have been described and illustrated, it is to be understood that that the scope of the invention as set forth in the claims is not to be limited to the particular embodiments discussed. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

What is claimed is:

1. An imaging module for an image scanning and/or reading device, the imaging module comprising:
a camera module comprising:
a module body having a surface for receiving a circuit board, the surface including one or more recessed portions for preventing damage to the body when the one or more contacts of the circuit board are soldered.

2. The imaging module of claim 1, wherein the camera module further comprises an aiming lens having a cylindrical first surface and a cylindrical second surface disposed perpendicular to the first surface.

3. The imaging module of claim 1, wherein the camera module further comprises a memory programmed with module parameters.

4. The imaging module of claim 3, wherein the module parameters include LED illumination intensity, image sensor noise, an automatic exposure control function, a focusing function, aiming shape, the I/D module ID, and the I/D module manufacturing date.

5. The imaging module of claim 1, further comprising a temperature sensor for monitoring the temperature of the imaging module's environment.

6. The imaging module of claim 5, wherein the camera module further comprises an illumination light source, wherein the temperature sensor can be monitored by a processor to adjusts the pulse width of the illumination light source to compensate changes in luminous intensity with temperature.

7. The imaging module of claim 5, wherein the temperature sensor can be monitored by a processor so that if the imaging module is used outside of a specified temperature range of the imaging module, the temperature sensor can be used to reduce the clock frequency the processor to restrain heat generation and prevent malfunction of the processor.

8. The imaging module of claim 1, further comprising a decoder module disposed adjacent to the camera module.

9. The imaging module of claim 8, wherein the decoder module comprises a folded circuit board arrangement including parallel first and second circuit boards.

10. The imaging module of claim 9, wherein the decoder module has a height and width which are similar to a height and width of the camera module.

11. The imaging module of claim 9, further comprising a chassis module for mounting the camera and decoder modules.

12. The imaging module of claim 9, wherein the first and second circuit boards are electrically connected by a flexible printed circuit.

13. The imaging module of claim 9, wherein the first circuit board includes at least a processor and a memory.

14. The imaging module of claim 13, wherein the second circuit board includes at least an interface control processor.

15. The imaging module of claim 14, wherein one of the first and second circuit boards includes a second memory.

16. The imaging module of claim 14, wherein one of the first and second circuit boards includes a second memory and a power supply.

17. The imaging module of claim 14, wherein one of the first and second circuit boards includes a second memory and the other one of the first and second circuit boards includes a power supply.

18. The imaging module of claim 9, wherein the decoder module includes a spacer disposed between the first and second circuit boards.

19. The imaging module of claim 8, further comprising a chassis module for mounting the camera and decoder modules.

20. The imaging module of claim 19, wherein the chassis module includes a main chassis and the decoder module includes a processor, the main chassis including a portion that engages the processor to transfer heat from the processor into the main chassis.

21. The imaging module of claim 1, further comprising a chassis module for mounting the camera module.

22. The imaging module of claim 21, wherein the chassis module includes a main chassis having a portion that engages a processor to transfer heat from the processor into the main chassis.

23.-44. (canceled)
